(19) United States
(12) Patent Application Publication
(10) Pub. No.: US 2013/0346266 A1
(43) Pub. Date: Dec. 26, 2013

(54) SYSTEM AND METHOD OF IDENTIFYING TRANSACTIONS OVER A PAYMENT CARD NETWORK SUBJECTABLE TO A CONDITIONAL CONSUMPTION TAX

(71) Applicant: JUSTIN XAVIER HOWE, Larchmont, NY (US)

(72) Inventor: JUSTIN XAVIER HOWE, Larchmont, NY (US)

(73) Assignee: MASTERCARD INTERNATIONAL, INC., Purchase, NY (US)

(21) Appl. No.: 13/528,977

(22) Filed: Jun. 21, 2012

(51) Int. Cl. G06Q 40/00; G06Q 20/40

(52) U.S. Cl. 705/31

(57) ABSTRACT

In one aspect, a method is provided herein of identifying transactions being processed over a payment card network which may be subjected to a conditional consumption tax. The method includes receiving, via the payment card network, a payment authorization message corresponding to a transaction between a user and a merchant. Further, the method includes determining, using a computer, from the payment authorization message, a user geographical code for the user. Similarly, the method includes determining, using a computer, from the payment authorization message, a merchant geographical code for the merchant. Using a computer, the method calls for comparing the geographical code of the user and the geographical code of the merchant with a demesne of a first tax authority. If the geographical code of the user and the geographical code of the merchant are within the demesne of the first tax authority, then, determining the transaction has no conditional consumption tax burden under the first tax authority. If the geographical code of the user and the geographical code of the merchant are not both within the demesne of the first tax authority, then, identifying the transaction as subjectable to conditional consumption tax by the first tax authority. Advantageously, with the method of the subject invention, transactions over a payment card network can be reviewed to determine if conditional consumption taxes, such as use taxes, apply while being normally processed.

### FIELD OF THE INVENTION

The subject invention relates to methods of identifying transactions over a payment card network which may be subjected to a conditional consumption tax.

### BACKGROUND OF THE INVENTION

Consumption taxes, such as sales taxes and value added taxes (VAT's), are charged by many government authorities at various levels. Typically, these taxes are ad valorem taxes charged by the merchant at the time of the purchase. Merchants are responsible to pay these taxes to relevant tax authorities.

With certain transactions, additional or different tax schemes may apply. For example, certain jurisdictions impose a use tax on transactions by residents outside the residence jurisdiction. Typically, the use tax only applies to any positive difference between the sales tax rate of the home jurisdiction versus the sales tax rate of the jurisdiction of the situs of the transaction. Most merchants do not charge the use tax at the time of the transaction.

Due to differences between the laws of different states and regions, uniform application of use tax is not possible. Efforts have been made, such as with the Streamlined Sales Tax Project (SSTP) (www.streamlinedsalestax.org), to harmonize sales and use taxes. Without full participation, such initiatives are of limited value.

Systems have been developed in the prior art to determine use tax. U.S. Pat. No. 5,875,433 to Francisco et al. discloses a system which determines whether use tax applies to sales made over the Internet, by catalogue, and by direct mail based on a customer's shipping address. If it is determined that use tax applies, the system automatically charges the consumer the use tax as part of the transaction. U.S. Published Patent Application No. 2005/0216351 A1 to Holbert et al. discloses a method where sales information is transmitted to a central processing center. Geocoding may be used to evaluate the locations of the consumers and the merchants to determine if use tax applies. U.S. Published Patent Application No. 2003/0040992 A1 to Ryan, Jr. et al. discloses the use of a meter which maintains a log of all sales and use tax transactions, with the aggregate data being transmitted to a certified service provider. Although different systems have been utilized to handle use taxes, no system requires one implementation for a plurality of merchants.

It is also noted that other taxes, such as excise taxes (“sin” taxes), duty, and tourism taxes, as examples, are applied non-uniformly to transactions. For example, taxes may be applied only against certain goods (e.g., excise taxes applied against liquor).

### SUMMARY OF THE INVENTION

In one aspect, a method is provided herein of identifying transactions being processed over a payment card network which may be subjected to a conditional consumption tax. The method includes receiving, via the payment card network, a payment authorization message corresponding to a transaction between a user and a merchant. Further, the method includes determining, using a computer, from the payment authorization message, a user geographical code for the user. Similarly, the method includes determining, using a computer, from the payment authorization message, a merchant geographical code for the merchant. Using a computer, the method calls for comparing the geographical code of the user and the geographical code of the merchant with a demesne of a first tax authority. If the geographical code of the user and the geographical code of the merchant are within the demesne of the first tax authority, then, determining the transaction has no conditional consumption tax burden under the first tax authority. If the geographical code of the user and the geographical code of the merchant are not both within the demesne of the first tax authority, then, identifying the transaction as subjectable to conditional consumption tax by the first tax authority. Advantageously, with the method of the subject invention, transactions over a payment card network can be reviewed to determine if conditional consumption taxes, such as use taxes, apply while being normally processed.

As used herein, a “conditional consumption tax” is a tax which is not uniformly applied to purchases, but, rather, is applied conditionally (i.e., applied where certain conditions are met). Examples of conditional consumption taxes include excise taxes, use taxes, duty and tourism taxes. As will be appreciated by those skilled in the art, additional taxes beyond the examples provided may fall within the definition of conditional consumption tax.

These and other features of the invention will be better understood through a study of the following detailed description and accompanying drawings.

### BRIEF DESCRIPTION OF DRAWINGS

FIG. 1 is a schematic of a system in accordance with the subject invention;

FIG. 2 is a flow chart of a method in accordance with the subject invention; and,

FIGS. 3-5 are flow charts of further embodiments in accordance with the subject invention.

### DETAILED DESCRIPTION OF THE INVENTION

A system and methodology are provided herein for identifying transactions being processed over a payment card network which are subjectable to a conditional consumption tax. As used herein, a “payment card network” relates to any network over which electronic payment may be made. This includes not only credit card and debit card based networks, but also cardless networks where identification numbers and other parameters may be used electronically to conduct a financial transaction. By way of non-limiting examples, the Automated Clearinghouse (ACH) network is considered to be a payment card network, as well as, networks which permit wireless devices to conduct payment, whether or not Internet based.

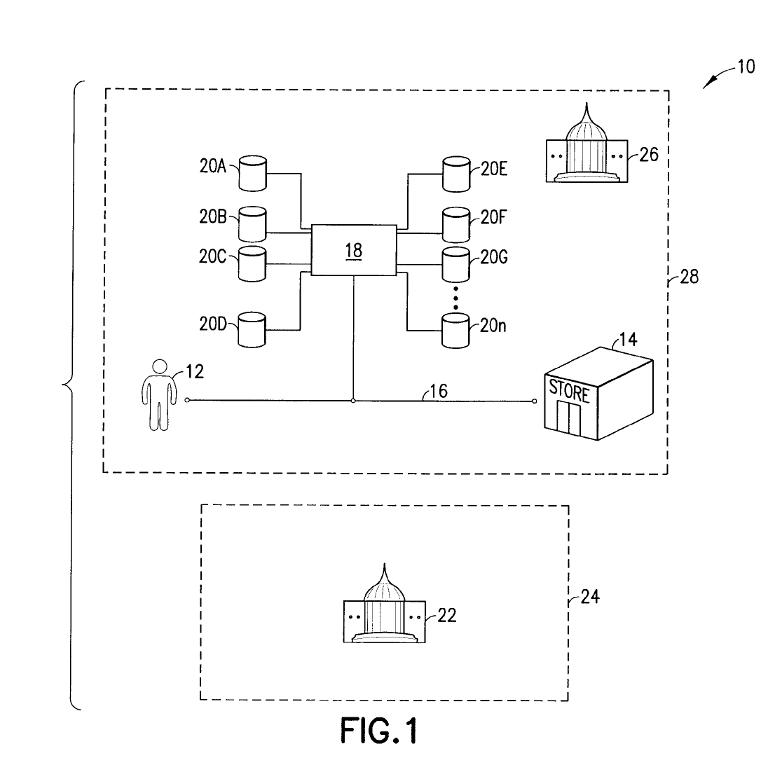

With reference to FIG. 1, a system 10 is shown usable for the subject invention where a user 12 conducts a transaction with a merchant 14. The transaction may be conducted on-site at the merchant's 14 location, or, alternatively, the transaction may be an electronic-commerce-type transaction conducted with the user 12 being located remotely from the merchant 14, such as over the Internet or other wired or wireless networks. The transaction is conducted over a payment card network 16 which is represented schematically by a line connecting the user 12 to the merchant 14. It is understood that the payment card network 16 may be of various configurations which permit the transaction to ultimately culminate in a payment authorization message authorizing payment to the merchant 14. The payment card network 16 may involve various hardware components (servers, routers, etc.) not shown here.

A controller 18 is operatively linked to the payment card network 16, such as by wireless or wired connection, so as to receive payment authorization messages being transmitted over the payment card network 16. The controller 18 may be one or more computer processing unit(s) (CPU) as is known in the art. The functionality of the controller 18 is discussed below. One or more databases or look-up tables 20A, 20B . . . 20ₙ may be included within the controller 18, or linked thereto, which include information for reference. The databases 20A, 20B . . . 20ₙ may be each stand-alone or combined in various combinations.

The system 10 is used to identify transactions which may be subjected to a conditional consumption tax. The geographical location of the user 12 and the geographical location of the merchant 14 may be significant to determine whether the transaction is subjectable to conditional consumption tax of a first tax authority 22. In general, a first demesne 24 will define the extent of the taxing authority of the first tax authority 22. For example, the location of the transaction within the first demense 24 versus outside of the first demense 24 may define conditional consumption tax burden relative to the first tax authority 22. It is noted that a transaction may be subjected to more than one conditional consumption tax burden, such as, for example, as shown schematically in FIG. 1, where a second tax authority 26 having a second demesne 28, is implicated. As will be appreciated by those skilled in the art, additional tax authorities may be implicated. The tax authorities may be at any government level, such as city, county, state or national level. As such, it is possible then for a transaction to be subject to both a city-level conditional consumption tax, as well as, a state-level conditional consumption tax simultaneously with other combinations being possible.

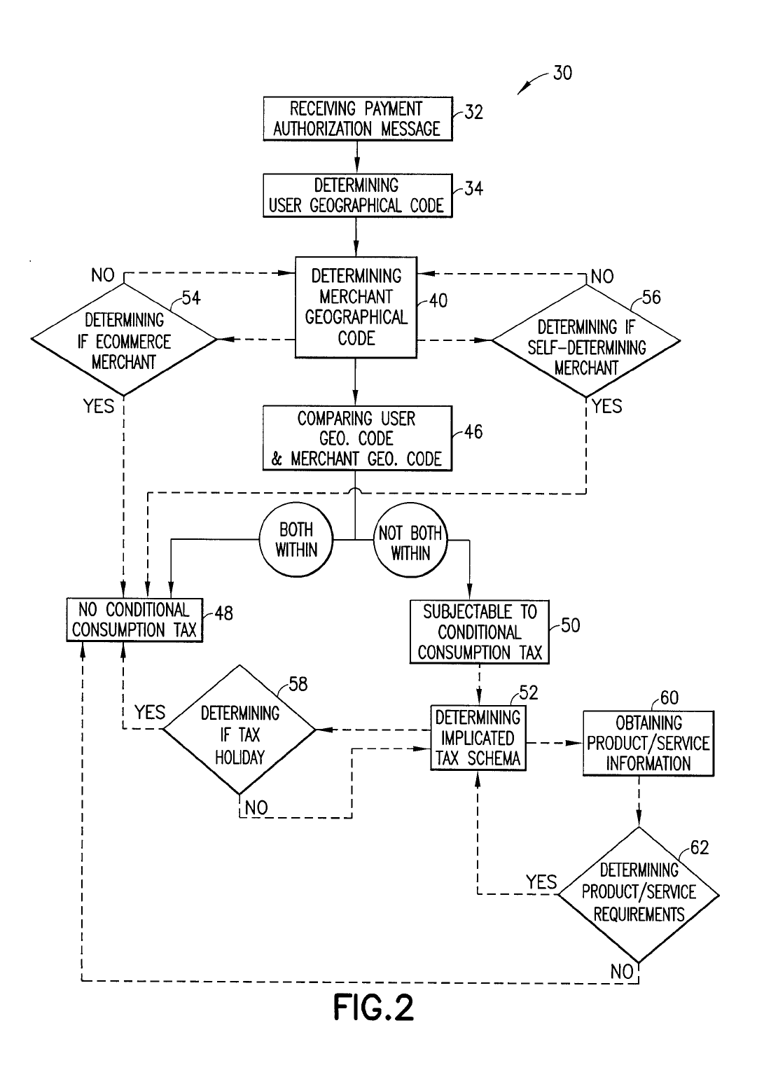

With reference to FIG. 2, a method 30 is provided for identifying transactions being processed over the payment card network 16 which may be subjectable to a conditional consumption tax. In a first step 32, a payment authorization message is received by the controller 18, via the payment card network 16, which corresponds to a transaction between the user 12 and the merchant 14. With the controller 18 being operatively linked to the payment card network 16, payment authorization messages may be received in real-time during the processing of the transaction. Upon receipt, and prior to processing, the payment authorization messages may be temporarily stored, such as in a buffer (not shown) within, or linked to, the controller 18, to permit processing in sequence of a large volume of payment authorization messages. Although the payment authorization messages may be received in real-time, there may be a delay to processing by the controller 18.

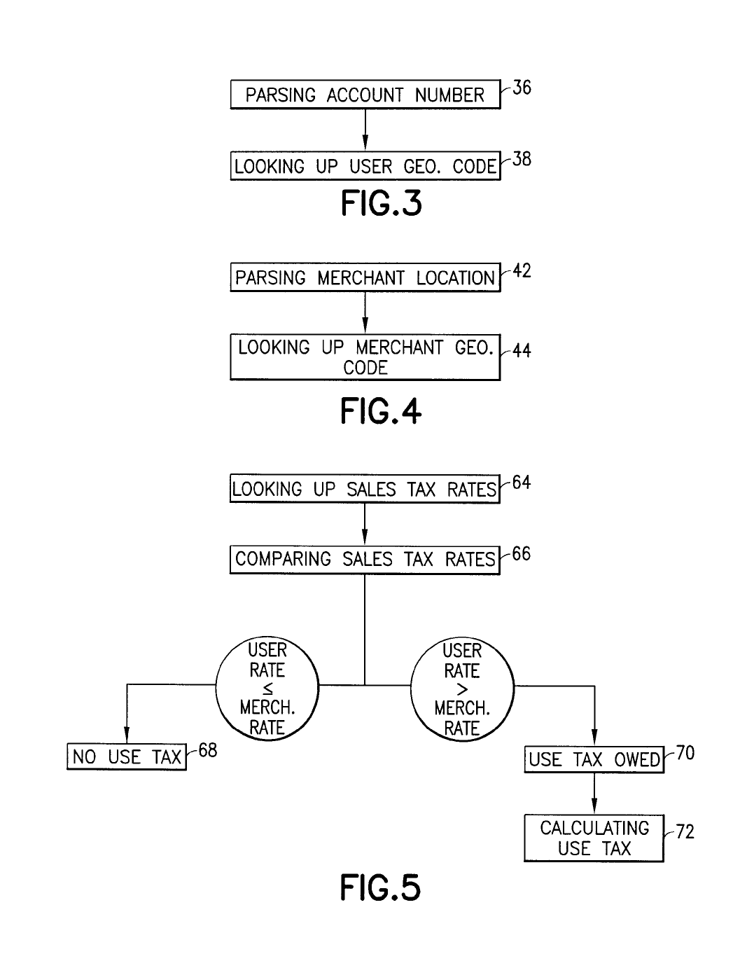

Once received, as shown in second step 34, using the controller 18, a geographical code for the user 12 is determined from the payment authorization message. The geographical code may be determined by any method known. Preferably, as shown in FIG. 3, the geographical code is determined by parsing the user's 12 account number from the information transmitted with the payment authorization message (step 36). Under ISO 8583, a primary account number (PAN) is a transmitted data element and is, thus, transmitted with standard electronic transactions. Once parsed, the controller 18 looks up a corresponding geographical code using database 20A, which includes a cross-reference listing of user account numbers versus user residence information (step 38). The geographical code is taken from the user residence information. Preferably, the user geographical code is a postal code (e.g., zip code), and more preferably, is an extended postal code (e.g., extended zip code with four additional digits (nine total digits)).

With respect to step 40, the controller 18 acts to determine from the payment authorization message a merchant geographical code for the merchant 14. Preferably, with reference to FIG. 4, the payment authorization message is parsed to determine a merchant location for the transaction (step 42). Under ISO 8583, a card acceptor location is a transmitted data element and is, thus, transmitted with standard electronic transactions. Under ISO 8583, the card acceptor location, which is the merchant location for the transaction, is specified by 40 characters with characters 1-23 being reserved for street address, characters 24-36 being reserved for city, characters 37-38 being reserved for state, and characters 39-40 being reserved for country. This information is parsed from the payment authorization message under the step 42. The merchant geographical code may be determined from the merchant address information. For example, the state postal code may be utilized as the merchant geographical code. More preferably, once parsed, the controller 18 looks up a merchant geographical code using database 20B, which includes a cross-reference listing of address information versus postal codes (step 44). Preferably, the merchant geographical code is a postal code (e.g., zip code), and more preferably, is an extended postal code (e.g., extended zip code with four additional digits (nine total digits)).

It is noted that payment authorization messages may be configured to include additional address information of the merchant 14, including a postal code or an extended postal code (e.g., as transmitted data elements). If payment authorization messages are utilized containing such information, the step 40 of determining may be conducted by parsing the payment authorization message to identify the postal code or extended postal code as the merchant geographical code.

One significant form of conditional consumption tax is use tax. With use tax, a tax authority may seek to impose a tax burden on a resident who conducts what would be a taxable transaction within the demesne of the tax authority, outside of the demesne of the tax authority, thus avoiding standard tax burden. For example, state-level sales tax may be avoided by conducting a transaction outside the state. To avoid loss of revenue, many jurisdictions impose a use tax on transactions outside of the jurisdiction which is equal to any difference between the applicable tax burden within the demesne of the jurisdiction versus any tax actually paid. Typically, use tax does not exceed the tax burden which would have been applied to the transaction within the demesne of the jurisdiction.

Geographic location of the merchant 14 versus the residence of the user 12 is important to determining use tax, particularly relative to the demesne of a tax authority. In addition, geographic location of the merchant 14 versus the residence of the user 12 is important to determining other forms of conditional consumption tax, such as duty (user is conducting transaction outside home country) and tourism taxes (user is conducting transaction in foreign jurisdiction (can be city, county, state or country)). With these forms of conditional consumption tax, it is important to determine if the location of the merchant 14 is outside of the user's 12 home jurisdiction relative to the demesne of a tax authority.

With reference to step 46, the controller 18 compares the user geographical code of the user 12 and the merchant geographical code of the merchant 14 to determine if the transaction is subjectable to a conditional consumption tax. If the user geographical code and the merchant geographical code are within the demesne of the same tax authority (e.g., within the first demesne 24 of the first tax authority 22), it can be determined that no conditional consumption tax (e.g., of the first tax authority 22) is applicable (step 48). If the user geographical code and the merchant geographical code are not within the demesne of the same tax authority, it is then determined that the transaction may be subjectable to conditional consumption tax (step 50).

As an additional optional step, under step 52, the controller 18 utilizes the user geographical code and/or the merchant geographical code to determine the tax schema of which tax authorities may be implicated by the transaction, such as a tax schema of the first tax authority 22. Preferably, the implicated tax schema is determined by the controller 18 looking up database 20C, which includes a cross-reference of postal codes versus implicated tax schema. This allows for determining how many tax authorities, and, optionally, what tax schema, may be implicated by the transaction. It is possible that more than one tax schema may be implicated for a particular tax authority. The step 52 may be conducted at various junctures in the method 30, not necessarily after the step 50.

Various schema of conditional consumption tax may apply. For example, it may be determined that the first tax authority 22 applies use tax to all transactions outside of the first demesne 24 (e.g., where the user 12 resides within the first demesne 24). Thus, if the merchant 14 is outside of the first demesne 24, the transaction can be considered to be subjectable to conditional consumption tax in the form of use tax. Alternatively, if the merchant 14 is located outside the home country of the user 12, the transaction may be subjectable to conditional consumption tax in the form of duty. Further, it may be determined that the second tax authority 26 may have authority to apply tourism tax to transactions within the second demesne 28 where the user 12 resides outside the second demesne 28.

It is noted that merchants generally do not calculate or collect conditional consumption taxes, because of inability to accurately determine if relevant conditions are satisfied to apply such taxes. With respect to the method 30 described above, once a transaction has been identified as being subjectable to conditional consumption tax, such as in the form of use tax, this information may be transmitted by the controller 18 to the relevant tax authority, e.g. the first tax authority 22, for processing. The tax authority may issue a notice to the user 12 indicating that there is a conditional consumption tax burden with the user 12 being allowed to dispute the application of the tax.

As will be appreciated by those skilled in the art, the system 10 and the method 30 allow for real-time review of transactions to evaluate possible conditional consumption tax burden.

The method 30 may optionally include further considerations to determine if conditional consumption tax is applicable. For example, with reference to step 54, there can be a determination if the merchant 14 is an electronic commerce (ecommerce) merchant. In general, electronic commerce transactions are not subject to taxes. As such, if the merchant 14 is identified as an electronic commerce merchant, it is then determined that there is no conditional consumption tax (step 48). If the merchant 14 is not identified as an electronic commerce merchant, the method 30 continues as described above. Any method for identifying the merchant 14 as an electronic commerce merchant may be utilized. Preferably, the controller 18 looks up database 20D which includes a listing of electronic commerce merchants.

Also, certain merchants self-determine conditional consumption tax (i.e., calculate the relevant tax burden). The self-determining merchants may collect the taxes or simply report the transaction with the relevant tax authority doing the collecting. The method 30 may include step 56 which determines if the merchant 14 is a self-determining merchant. If the merchant 14 is identified as a self-determining merchant, it is then determined that there is no conditional consumption tax (step 48). If the merchant 14 is not identified as a self-determining merchant, the method 30 continues as described above. Any method for identifying the merchant 14 as a self-determining merchant may be utilized. Preferably, the controller 18 looks up database 20E which includes a listing of self-determining merchants. The databases 20D and 20E may be combined as one database.

Occasionally, tax authorities provide “tax holidays” or amnesties where during certain periods of time conditional consumption taxes may be not applicable. The method 30 may include step 58 to determine if any such tax holidays apply. This determination is in the context of a particular tax authority. If a tax holiday applies, it is then determined that there is no conditional consumption tax (step 48). If a tax holiday does not apply, the method 30 is conducted as described above. Any method for identifying a tax holiday may be utilized. Preferably, the controller 18 looks up database 20F which includes a listing of tax holidays.

Certain conditional consumption taxes may be product or service specific. For example, certain use taxes and excise taxes may apply only to particular goods (e.g., liquor purchased out of state). Also, tourism tax may apply to certain services, such as hotel charges. The method 30 may include step 60 of evaluating product/service information related to the transaction. For example, the payment authorization message may be configured to include as a data element, an industry classification which provides a classification of the related goods/services. The step 60 would then include parsing the payment authorization message to extract the relevant information. Under step 62, the controller 18 looks up the database 20C, or a different database, to determine if the applicable tax schema has any product or service requirements. If such requirement(s) exist, and the product/service of the transaction do not match, it is then determined that there is no conditional consumption tax (step 48). If such requirements do not exist, or if such requirements exist and the product/service of the transaction match, the method 30 is conducted as described above.

It is noted that, alternatively, the system 10 may be configured to send a prompt to the merchant 14 during the transaction to enter a product/service identifier if an industry classification is not included with the payment authorization message. The entered product/service information is then used in the step 62 in the same manner as described above.

The method 30 may be used to determine the amount of use tax for a transaction processed over the payment card network 16. In particular, the method 30 is conducted as set forth above. In addition, once a transaction is identified as subjectable to conditional consumption tax in the form of use tax, the additional steps set forth in FIG. 5 may be utilized. As set forth therein, in step 64, the controller 18 looks up database 20G which includes a listing of sales tax rates cross-referenced with geographical information, preferably postal codes. In this manner, the controller 18 may determine the sales tax rate of the jurisdiction in which the user 12 resides (based on the user geographical code), and the controller 18 may determine the sales tax rate of the jurisdiction in which the merchant 14 involved in the transaction is located (based on the merchant geographical code).

In step 66, the sales tax rate of the user's 12 jurisdiction is compared with the sales tax rate of the merchant's 14 jurisdiction. If it is determined that the sales tax rate of the user's 12 jurisdiction is equal to or less than the sales tax rate of the merchant's 14 jurisdiction, it is determined that no use tax is owed (step 68). If it is determined that the sales tax rate of the user's 12 jurisdiction is greater than the sales tax rate of the merchant's 14 jurisdiction, it is determined that use tax is owed (step 70). The use tax is calculated by taking the difference between the sales tax rate of the user's 12 jurisdiction and the sales tax rate of the merchant's 14 jurisdiction, and multiplying that difference by the amount of the transaction (step 72). The amount of the transaction will typically equal the untaxed amount of the transaction (i.e., the amount without any tax applied thereto). The calculated use tax can be reported to the relevant tax authority for collection or passed along for other forms of collection. It is noted that more than one use tax can apply to a single transaction with each use tax being calculated as set forth herein (e.g., city level use tax; county level use tax; and/or, state level use tax).

1. A method of identifying transactions being processed over a payment card network subjectable to a conditional consumption tax, said method comprising:
receiving, via the payment card network, a payment authorization message corresponding to a transaction between a user and a merchant;
parsing, pursuant to ISO 8583, a user account number from said payment authorization message;
determining, using a computer, from said user account number, a user geographical code for said user;
determining, using a computer, from said payment authorization message, pursuant to ISO 8583, a merchant geographical code for said merchant; and,
comparing, using a computer, said geographical code of said user and said geographical code of said merchant with a demesne of a first tax authority, wherein,
if said geographical code of said user and said geographical code of said merchant are within the demesne of the first tax authority, then, determining said transaction has no conditional consumption tax burden under the first tax authority, and,
if said geographical location of said user and said geographical location of said merchant are not both within the demesne of the first tax authority, then, identifying said transaction as subjectable to conditional consumption tax by the first tax authority.

2. A method as in claim 1, further comprising comparing, using a computer, said geographical location of said user and said geographical location of said merchant with a demesne of a second tax authority, wherein,
if said geographical location of said user and said geographical location of said merchant are within the demesne of the second tax authority, then, determining said transaction has no conditional consumption tax burden under the second tax authority, and,
if said geographical location of said user and said geographical location of said merchant are not both within the demesne of the second tax authority, then, identifying said transaction as subjectable to conditional consumption tax by the second tax authority.

3. A method as in claim 1, further comprising comparing said merchant with a database of electronic commerce merchants to determine if said merchant is an electronic commerce merchant.

4. A method as in claim 3, wherein, if said merchant is identified as an electronic commerce merchant, then, determining said transaction has no conditional consumption tax burden under the first tax authority.

5. A method as in claim 1, further comprising comparing said merchant with a database of merchants who self-determine conditional consumption tax burdens for transactions to determine if said merchant is a self-determining merchant.

6. A method as in claim 5, wherein, if said merchant is identified as a self-determining merchant, then, determining said transaction has no conditional consumption tax burden under the first tax authority.

7. A method as in claim 1, further comprising parsing, using a computer, said payment authorization message to identify an industry classification.

8. A method as in claim 7, further comprising determining, based on said industry classification, if the first tax authority applies conditional consumption tax to said transaction.

9. A method as in claim 1, further comprising determining if said transaction occurred during a tax holiday authorized by the first tax authority.

10. A method of determining use tax of transactions being processed over a payment card network, said method comprising:
receiving, via the payment card network, a payment authorization message corresponding to a transaction between a user and a merchant;
parsing, pursuant to ISO 8583, a user account number from said payment authorization message;
determining, using a computer, from said user account number, a user geographical code for said user;
determining, using a computer, from said payment authorization message, pursuant to ISO 8583, a merchant geographical code for said merchant;
comparing, using a computer, said geographical code of said user and said geographical code of said merchant with a demesne of a first tax authority, wherein,
if said geographical code of said user and said geographical code of said merchant are within the demesne of the first tax authority, then, determining said transaction has no use tax burden under the first tax authority, and,
if said geographical code of said user and said geographical code of said merchant are not both within the demesne of the first tax authority, then, determining use tax for said transaction by,
comparing, using a computer, the sales tax rate of the first tax authority with the sales tax rate of said geographical code of said merchant, wherein,
if the sales tax rate of the first tax authority is equal to or less than the sales tax rate of said geographical code of said merchant, then, determining said transaction has no use tax burden under the first tax authority, and,
if the sales tax rate of the first tax authority is greater than the sales tax rate of said geographical code of said merchant, then, determining the difference between the sales tax rate of the first tax authority and the sales tax rate of said geographical code of said merchant, and multiplying said difference by the amount of said transaction to determine the use tax for said transaction.

11. A method as in claim 10, further comprising comparing said merchant with a database of electronic commerce merchants to determine if said merchant is an electronic commerce merchant.

12. A method as in claim 11, wherein, if said merchant is identified as an electronic commerce merchant, then, determining said transaction has no use tax burden under the first tax authority.

13. A method as in claim 10, further comprising comparing said merchant with a database of merchants who self-determine use tax burdens for transactions to determine if said merchant is a self-determining merchant.

14. A method as in claim 13, wherein, if said merchant is identified as a self-determining merchant, then, determining said transaction has no use tax burden under the first tax authority.

15. A method as in claim 10, further comprising parsing, using a computer, said payment authorization message to identify an industry classification.

16. A method as in claim 15, further comprising determining, based on said industry classification, if the first tax authority applies use tax to said transaction.

17. A method as in claim 10, further comprising determining if said transaction occurred during a tax holiday authorized by the first tax authority.
